(19) United States
(12) Patent Application Publication
(10) Pub. No.: US 2013/0304516 A1
(43) Pub. Date: Nov. 14, 2013

(54) SYSTEM AND METHOD FOR VALIDATING AUDIT DATA RELATED TO THE PERFORMANCE OF INSURANCE RELATED TASKS

(71) Applicant: Benjamin I. Schimelman, Middletown, CT (US)

(72) Inventor: Benjamin I. Schimelman, Middletown, CT (US)

(73) Assignee: HARTFORD FIRE INSURANCE COMPANY, Hartford, CT (US)

(21) Appl. No.: 13/468,719

(22) Filed: May 10, 2012

(51) Int. Cl. G06Q 40/08; G06Q 10/00

(52) U.S. Cl. 705/4; 705/30

(57) ABSTRACT

Disclosed herein are computer-implemented methods, computing systems, and related technologies that may be used for the verification of self-audits that are performed by a third-party service provider for an insurance company. Periodically, the service provider performs a self-audit, providing audit information to the insurance company that indicates whether the service provider has been meeting required service levels. An auditing application may be used to analyze the audit information provided by the service provider, and to determine whether the service provider's self-audit was accurate. Further, the auditing application provides functionality for determining what portions of the provided audit data have been validated, and for searching and displaying the audit and validation information.

### BACKGROUND

In the context of business process outsourcing, a company may rely on third-party service providers to assist the company in performing repeatable business tasks. As an example, an insurance company may engage a third-party service provider to perform tasks such as transmitting notifications to claimants, verifying the data included in incoming documents, and matching incoming documents (such as medical bills or other documents) to existing claims.

Typically, a company that employs a third-party service provider will want some mechanism in place to ensure the quality of the service provider's work. In some instances, a third-party service provider may perform “self-audits” (i.e., may audit their own performance), and provide corresponding self-audit information to the company. In some circumstances, it may be sufficient for the company to rely upon the service provider's own audit; in other circumstances, however, it may be desirable for the company to be able to validate the accuracy of the service provider's audit. Thus, the technologies described herein (which may be used for, among other purposes, validating self-audits performed by service providers) would be advantageous.

### SUMMARY

Described herein is a system for validating audit data includes a data storage device, a processor, and a display device. The audit data relates to a service that is provided by a service provider to an insurance company, and the service includes the performance of repeatable insurance related tasks. The data storage device is configured to store information that defines a service level agreement (SLA) between the service provider and the insurance company, wherein the service is performed according to the SLA. The data storage device is further configured to store information that includes task completion records for a plurality of the insurance related tasks completed by the service provider according to the SLA, wherein the task completion records include, for each of the insurance related tasks, information that uniquely identifies the insurance related task and information that indicates a time the insurance related task was completed. Additionally, the data storage device is configured to store audit information that indicates a level of performance for the plurality of the insurance related tasks completed by the service provider, wherein the audit information indicates the level of performance for the insurance related tasks for each of a plurality of time periods, wherein the audit information is based on only a first subset of the task completion records, wherein the first subset of the task completion records is a strict subset of the task completion records, and wherein the audit information is provided by the service provider. The processor is configured to receive user input data that indicates whether the audit information has been validated for one or more of the time periods, wherein the audit information is considered validated for one of the time periods when the level of performance for the plurality of the insurance related tasks for the time period indicated in the audit information has been independently verified as correct by the insurance company, and wherein the user input data is based on only a second subset of the task completion records, wherein the second subset of the task completion records is a strict subset of the first subset of the task completion records. The processor is further configured to generate a user interface element that includes a validation information area, wherein the validation information area indicates whether the audit information has been validated for all of the time periods or only a portion of the time periods. The display device is configured to display the user interface element.

Described herein is a computer-implemented method for validating audit data that is related to a service provided by a service provider to a financial services company, where the service includes the performance of repeatable business tasks. The method includes storing, in a data storage device, information that includes task completion records for a plurality of the business tasks completed by the service provider. The method further includes storing, in the data storage device, audit information for each of a plurality of time periods, wherein the audit information indicates a level of performance of the business tasks for each the time periods, wherein the audit information is based on only a first subset of the task completion records, wherein the first subset of the task completion records is a strict subset of the task completion records, and wherein the audit information is provided by the service provider. The method further includes receiving, at a processor, user input data that indicates whether the audit information has been validated for one or more of the time periods, wherein the user input data is based on only a second subset of the task completion records, wherein the second subset of the task completion records is a strict subset of the first subset of the task completion records. The method further includes generating, at the processor, a user interface element that includes a validation information area, wherein the validation information area indicates whether the audit information has been validated for all of the time periods or only a portion of the time periods. The method further includes displaying, at a display device, the user interface element.

Described herein is a non-transitory computer-readable medium that has processor-executable instructions stored thereon which, when executed by at least one processor, will cause the at least one processor to perform a method for communicating with a service provider for the performance of a service and for validating audit data that is related to the service. The service may be a fax transcription service for transcribing faxes that relate to insurance claims. The method includes the at least one processor receiving data that defines transcribed faxes that have been transcribed at the service provider, wherein the transcribed faxes are related to insurance claims, and includes the at least one processor storing the data that defines the transcribed faxes in a database that is stored in a data storage device. The method further includes the at least one processor storing task completion records related to the transcribed faxes in the database, and further includes the at least one processor obtaining audit information for each of a plurality of time periods, wherein the audit information indicates a level of performance of the service for each the time periods, and wherein the audit information is provided by the service provider. The method further includes the at least one processor receiving, via an input interface, user input data that indicates whether the audit information has been validated for one or more of the time periods. The method further includes the at least one processor generating information that defines a user interface element that includes a validation information area, wherein the validation information area indicates whether the audit information has been validated for all of the time periods, and further includes the at least one processor providing the information that defines the user interface element to a display device via a display device interface.

### BRIEF DESCRIPTION OF THE DRAWINGS

A more detailed understanding may be had from the following description, given by way of example in conjunction with the accompanying drawings wherein:

FIG. 1 shows an example computing architecture that may be used for verifying self-audit information provided by a third-party service provider;

FIG. 2 shows an example window that may be used for a service provider to perform a self-audit;

FIGS. 3A-3B show windows that are displayed by an auditing application for navigating through the auditing application;

FIG. 4 shows a window that may be used by an insurance company for validating audit data provided by a service provider;

FIGS. 5 and 6A-6B show windows that include detailed audit information and validation information;

FIG. 7 shows a window that includes a graph of audit information;

FIG. 8 shows a window that includes a summary of audit information and validation information;

FIG. 9 shows an example method for receiving audit data and validating the audit data;

FIG. 10 shows a computing device that may be used for implementing features described herein;

FIG. 11 shows a tablet computing device that is a more specific example of the computing device of FIG. 10.

### DETAILED DESCRIPTION

Disclosed herein are computer-implemented methods, computing systems, and related technologies that may be used for the verification of self-audits that are performed by a third-party service provider for an insurance company. An agreement between the service provider and the insurance company specifies minimum service levels that the service provider must meet. Periodically, the service provider performs a self-audit, providing information to the insurance company that indicates whether the service provider has been meeting the required service levels. An auditing application (described in detail below) is used to analyze the audit information provided by the service provider and to verify that the service provider's self-audit was accurate. Additionally, the auditing application provides functionality for searching the audit information and displaying reports related to the audit information.

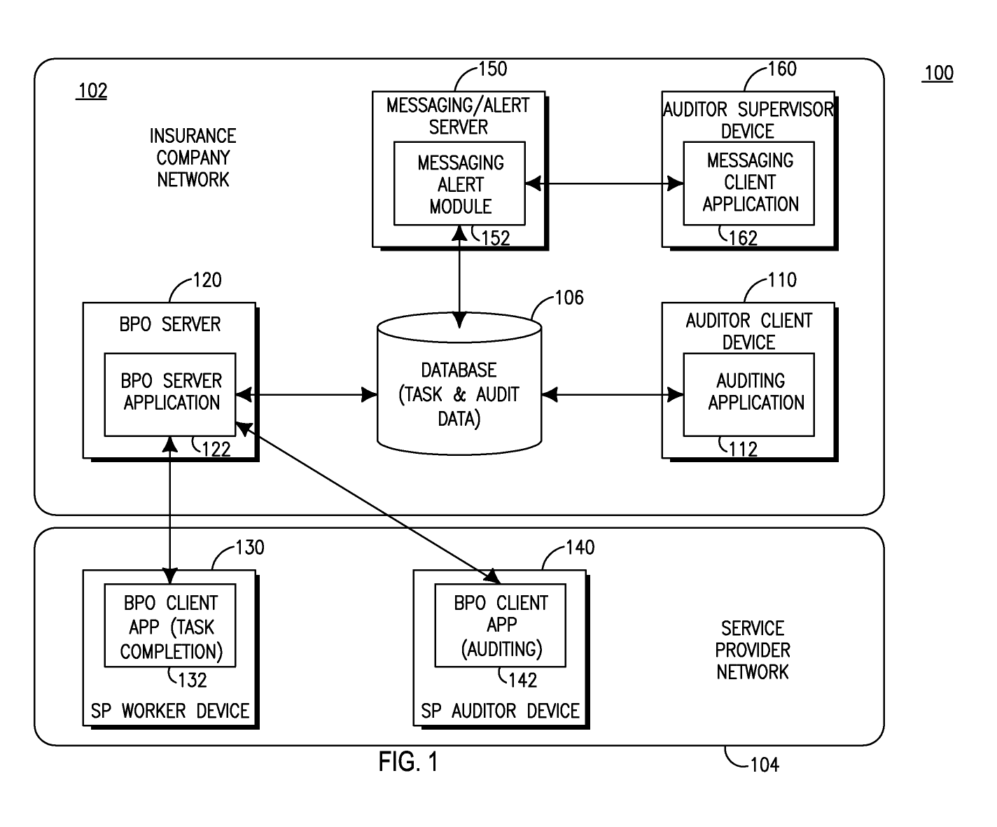

FIG. 1 shows an example architecture 100 that includes an insurance company network 102 and a service provider network 104. The insurance company network 102 is under the control of and/or operated by employees of an insurance company; the service provider network 104 is under the control of a third-party service provider. The insurance company network 102 includes a business process outsourcing (BPO) server 120, an auditor client device 110, and a database 106. The service provider network 104 includes a service provider worker device 130, a service provider auditor device 140, a messaging/alert server 150, and an audit supervisor device 160. The auditor client device 110, audit supervisor device 160, service provider worker device 130, and service provider auditor device 140 may be, for example, laptop computers, desktop computers, tablet computers, smartphones, and/or other appropriate devices. The BPO server 120 and the messaging/alert server 150 may be, for example, server computers or other appropriate computing devices. One or more service contracts exist between the service provider and the insurance company, and the service provider provides services to the insurance company pursuant to the service contracts. The services may include the performance of repeatable business tasks, such as transcribing faxes, handling data entry tasks, and other tasks. Periodically, the service provider may perform a self-audit, providing data to the insurance company regarding the performance of the service provider according to the service contracts. Using an auditing application 112 in the auditor client device 110, the insurance company may validate/verify the self-audit data provided by the service provider.

Each or any of the service contracts between the insurance company and the service provider may include a service level agreement (SLA), which defines the performance goals/requirements that are expected of the service provider for a given service. An SLA may specify the different metrics by which the service provider's performance will be judged. For example, an SLA may specify that the service provider will be judged according to different types of performance metrics, such as the quality (or accuracy) of task performance, the turnaround times (TATs) in which tasks are completed, the volume of tasks being handled by the service provider, and/or other metrics. Further, an SLA may specify multiple performance levels, such as an “expected” performance level and an “impacted” performance level. As an example, the “expected” performance level may require that the service provider must complete 90% of assigned tasks within one business day, while the “impacted” performance level may require that the service provider must complete 100% of assigned tasks within four business days. According to this example, the first level is referred to as an “expected” level of service because the insurance company expects to consistently receive at least this level of service from the service provider. The second level is referred to as an “impacted” level of service because, if the level of service provided by the service provider goes below this level, some aspect of the insurance company's business will be negatively impacted.

As mentioned above, the insurance company network 102 includes the BPO server 120. The BPO server 120 runs a BPO server application 122. Also as mentioned above, the service provider network 104 includes a worker device 130, which may be, for example, a laptop or desktop computer. The worker device 130 may be used by a worker at the service provider for providing services to the insurance company. The worker device 130 runs a BPO client application 132, which interacts with the BPO server application 122.

Via the BPO server application 122, the insurance company provides information to the BPO client application 132 about tasks that the user of the worker device 130 is asked to perform. Using the BPO client application 132, the user of the worker device 130 can complete the tasks and provide corresponding information back to the BPO server application 122. As an example, in an instance where the service provider is providing a service related to fax transcription, the BPO client application 132 may display an image of a fax that needs to be transcribed to the worker device 130; the user transcribes the text in the fax (providing the text as text input to the BPO client application 132), and the BPO client application 132 then provides the transcribed text back to the BPO server application 122. Then, the transcribed text (and related information, such as when the task was completed) may be stored in the database 106.

The service provider auditor device 140 also runs a BPO client application 142. Via this application 142, the user of the service provider auditor device 140 can perform audits of tasks that the service provider has performed, and then provide the audit results back to the insurance company network 102 (via, for example, the BPO server application 122) for storage in the database 106 in the insurance company network 102.

In some implementations, the BPO server application 122 and the BPO client applications 132, 142 in the worker device 130 and service provider auditor device 140 may be based on and/or use virtualization technologies, such as presentation virtualization technologies, application virtualization technologies, desktop virtualization technologies, or client virtualization technologies. Alternatively or additionally, the BPO server application 122 and the BPO client applications 132, 142 may be based on technologies such as Citrix XenApp, Microsoft Application Virtualization, and/or any other appropriate similar technology. As one example wherein presentation virtualization is used and wherein the service provider is providing a service related to fax transcription, the BPO server 120 and worker device 130 may be configured as follows: A fax transcription application (i.e., the application that is used by the user of the worker device 130 to transcribe faxes) is executed at the BPO server 120; information that describes the user interface generated by the fax transcription application is transmitted by the BPO server application 122 to the BPO client application 132 for display at the worker device 130; and user input data provided by users of the worker device 130 is transmitted from the BPO client application 132 to the BPO server application 122. In this example, the fax transcription application would appear to be executed natively at the worker device 130, but is actually executed at the BPO server 120; in this manner, the data involved in task completion is only displayed by the BPO client application 132, and is not stored in the worker device 130. Presentation virtualization for the BPO client application 142 in the service provider auditor device 140 may be implemented in a similar/analogous fashion.

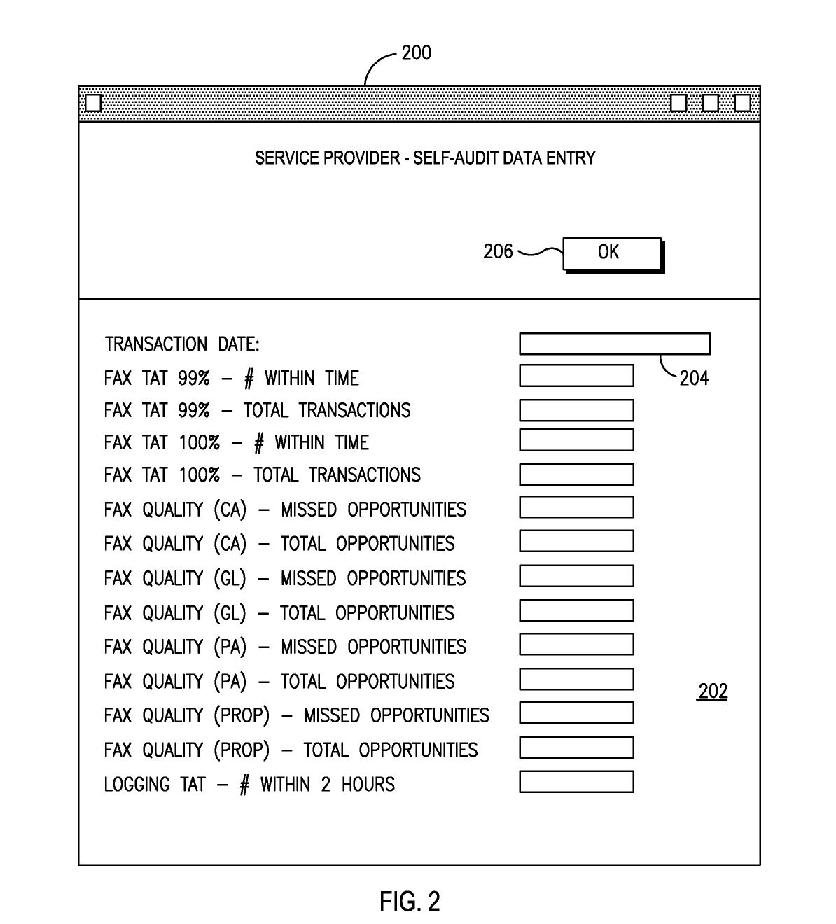

FIG. 2 shows an example window 200 that may be displayed by the BPO client application 142 in the service provider auditor device 140, and which may be used for the user of the service provider auditor device 140 to provide audit data related to tasks performed by the service provider. The window 200 of FIG. 2 includes an “Okay” button 206 and a data entry area 202. The data entry area 202 includes a transaction date field 204 and a number of other fields into which the user of the service provider auditor device 140 may provide input data. In the example of FIG. 2, the service provider provides a fax transcription service, and transcribes faxes that relate to four different business lines in the insurance company: a commercial automobile (CA) insurance line; a general liability (GL) insurance line; a personal auto (PA) insurance line; and a property insurance (prop) insurance line. According to this example, when a worker at the service provider is asked to transcribe a fax, each fax may constitute a number of different “opportunities.” As one example, each paragraph in a fax may be considered to be an “opportunity” to be correctly transcribed; if a fax includes four paragraphs, the fax is considered as including four “opportunities.”

As shown in FIG. 2, the data entry area 202 includes a number of fields that correspond to different SLAs and different types of data related to the SLAs. For example, the data entry area 202 includes a “Fax TAT 99%-# Within Time” field, which corresponds to a SLA related to whether the service provider has completed 99% of fax transcription tasks within a time prescribed according to the SLA; similarly, the data entry area 202 includes a “Fax TAT 99%-Total Transactions” field, which corresponds to the total number of opportunities related to this SLA. To fill in the fields in the data entry area 202 in the example window 200 of FIG. 2, the user of the service provider auditor device 140 fills in the transaction date field 204 with the date for which they are auditing records, and uses the BPO client application 142 (and/or another application) to view information about tasks that were performed on that date. This information may be stored, for example, in the database 106 in the insurance company network 102, and may be provided to the BPO client application 142 via the BPO server application 122, and/or in any other appropriate manner. This information may include digital copies of the original faxes that the workers at the service provider transcribed and a copy of the corresponding transcribed text that the worker at the service provider produced, so that the user can determine how many opportunities were available in the fax, and how many opportunities were successfully converted (i.e., performed correctly). Additionally, the information may indicate when fax tasks were initially received by the service provider and when they were completed, so that the user can determine the information to enter in the TAT-related fields in the data entry area 202. The user may then fill in the fields in the data entry area 202, indicating how many opportunities in each line on the given date were available, how many were missed, and so on.

When the user has completed entry of data into the fields in the data entry area 202, the user selects the “Okay” button 206. In response to selection of the “Okay” button, the BPO client application 142 then communicates the data that has been entered into the data entry area 202 to the insurance company network 102 (via, for example, to the BPO server application 122) for storage in the database 106 in the insurance company network 102.

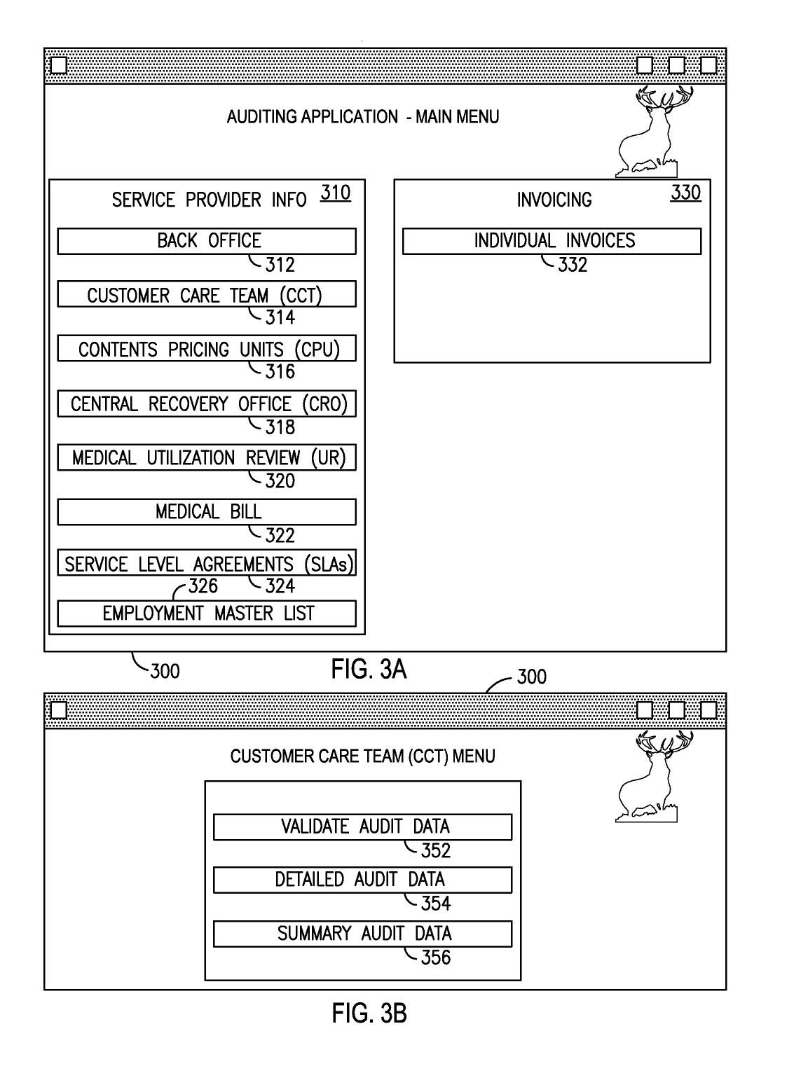

Referring back to FIG. 1, the auditor client device 110 in the insurance company network 102 includes an auditing application 112, which the user of the auditor client device may use to validate/verify the audit results provided by the service provider. Additionally, the auditing application 112 may provide searching and reporting functionality, for analyzing and generating reports related to the audit results provided by the service provider. Examples of windows and other user interface elements that may be generated/displayed by the auditing application 112 for implementing this functionality are provided below with reference to, inter alia, FIGS. 3A-9.

The messaging/alert server 150 in the insurance company network 102 includes a messaging/alert module 152. The messaging/alert module 152 may monitor data in the database 106 related to the validation/verification of the audit results, and sends corresponding messages to notify users of information related to the validation/verification. The messaging/alert module 152 may be configured to transmit email messages, instant messages, application-specific alert messages, and/or alert messages in other formats. The messaging/alert module 152 may periodically monitor the database 106 for updates, and/or may be triggered to analyze updated data in the database 106 whenever a relevant change in the data in the database 106 is made. The messaging/alert module 152 may be implemented as a Microsoft SharePoint workflow, and/or via any other appropriate technology.

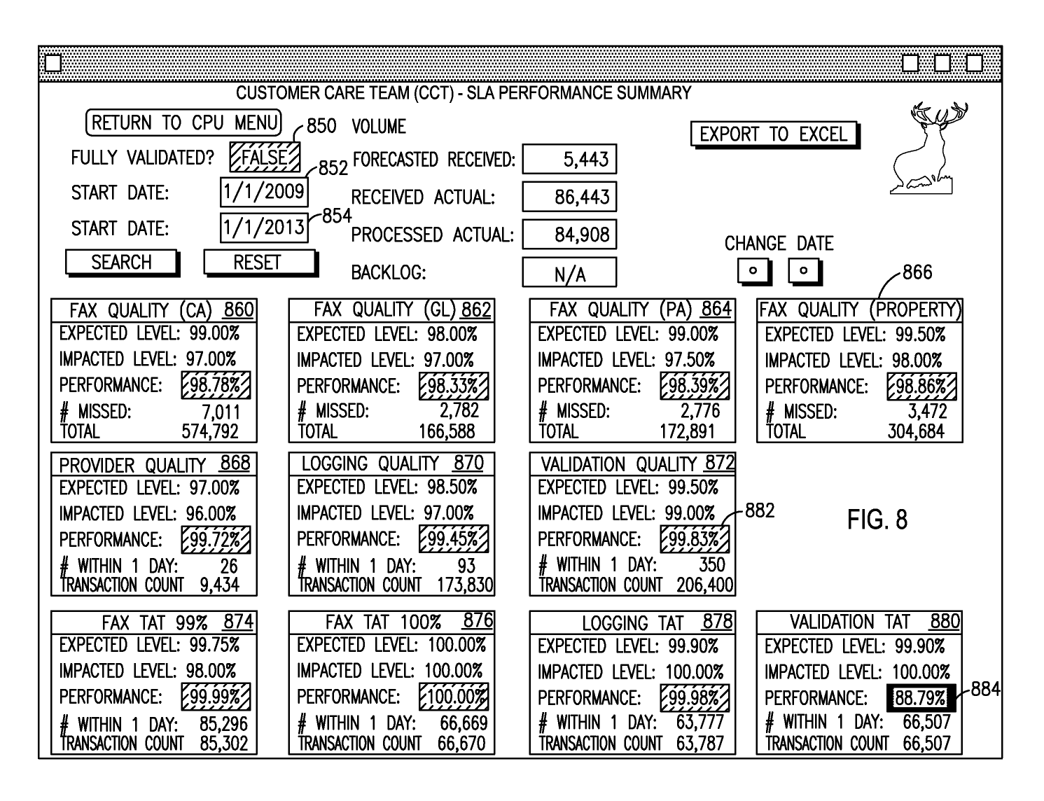

The audit supervisor device 160 in the insurance company network 102 may be used by, for example, a person at the insurance company who supervises the user of the auditor client device 110. A messaging client application 162 in the audit supervisor device 160 may receive alert messages that are transmitted by the messaging/alert module 152 in the messaging/alert server 150. The messaging client application 162 may be, for example, an email client application, a web browser application (for receiving email messages as webmail), an instant messaging application, and/or any other appropriate type of application. Further examples of alert messages that may be transmitted by the messaging/alert module 152 and received/displayed by the messaging client application 162 are provided below with respect to, inter alia, FIG. 9.

In an instance where the messaging/alert module 152 sends an email message for display by the messaging client application 162, the messaging/alert module 152 may do so via an email server (not depicted in FIG. 1) in the insurance company network 102. In such an instance, the messaging/alert module 152 may use a technology such a Simple Mail Transfer Protocol (SMTP) or an Remote Procedure Call (RPC) technology to transmit the email message to the email server, for corresponding delivery by the email server to the messaging client application 162.

The database 106 in the insurance company network 102 may be or include one or more relational databases, one or more hierarchical databases, one or more object-oriented databases, one or more flat files, one or more structured files, and/or one or more other files for storing data in an organized/accessible fashion. The database 106 may be spread across any number of computer-readable storage media. The database 106 may be managed by one or more database management systems, which may be based on technologies such as Microsoft SharePoint, Microsoft SQL Server, MySQL, PostgreSQL, Oracle Relational Database Management System (RDBMS), a NoSQL database technology, and/or any other appropriate technologies and/or combinations of appropriate technologies. When it is described herein that the BPO server application 122, the auditing application 112, and/or the messaging/alert module 152 stores data in or accesses data from the database 106, the BPO server application 122 or the auditing application 112 may do so via a database management system, driver program, and/or other interface, as appropriate.

A number of different types of data may be stored in the database 106. In additional or as an alternative to the information mentioned above as stored in the database 106, the database 106 may store information such as: task completion records related to tasks that are performed/completed by the service provider according to the service agreement, which include information, for each task, such as the nature of the task (i.e., which service it is associated with), when the task was assigned and completed, which worker at the service provider completed the task, a unique identifier for the task, other information that uniquely identifies the task, and/or information that was used by the service provider for completing the task; information regarding the audit data that is produced by and/or used by the user of the service provider auditor device 140; audit data that is used by the user of the auditing application 112 in the auditor client device 110; digital copies of SLAs between the service provider and the insurance company; and/or any of the information described herein as processed and/or otherwise handled by BPO client applications 132, 142, the BPO server application 122, and/or the auditing application 112.

In the architecture 100 of FIG. 1, the service provider may provide a number of different services to the insurance company. As already mentioned, the service provider may provide fax transcription services. Alternatively or additionally, the service provider may provide be a workers' compensation correspondence management service. According to this service, when the insurance company receives a new workers' compensation claim, BPO client application 132 in the worker device 130 receives and displays information related to the new claim. The user of the worker device 130 then sends corresponding initial notification letters, informational packets, and/or other correspondence to the appropriate parties (e.g., the claimant, the insured party, the claimants' attorney, or others) involved in the claim. Alternatively or additionally, the services may includes services such as handling incoming data entry tasks, contents pricing (pricing items that are lost/damaged in a claim), payment processing, customer care (first notice of loss), short-term disability and/or long-term disability intake, coverage verification, exception handling, making payments to medical providers (in the context of worker's compensation claims), making reimbursements to claimants, medical records collection, demand package handling, medical utilization reviews, medical operations (including handling payments and/or error corrections), processing invoices and/or correcting errors in invoices, adjudicating claims, claim set up, correcting errors in claim-related documents, and/or creating claim-related letters and/or other communications.

The communications described herein as taking place between the BPO server application 122, the auditing application 112, and the database 106 may be performed via the insurance company network 102. Although described for convenience as a single network, the insurance company network 102 may be or include one or more private wired and/or wireless networks that are under the control of and/or operated by the insurance company. The one or more private wired or wireless networks may be based on, for example, technologies such as Ethernet, Institute of Electrical and Electronics Engineer (IEEE) 802.11 technologies, and/or other technologies. Additionally, the communications described herein as taking place between the BPO server application 122 and the BPO client applications 132, 142 in the service provider network 104 may be performed via one or more public wired and/or wireless networks, and/or via the Internet.

Although the example architecture 100 of FIG. 1 shows a single BPO server 120, a single auditor client device 110, a single service provider worker device 130, and a single service provider auditor device 140, this is done for convenience in description, and it should be understood that the architecture 100 of FIG. 1 may include, mutatis mutandis, any number of such devices 110, 120, 130, 140. Alternatively or additionally, while the example architecture 100 of FIG. 1 shows only devices 110, 120, 130, 140 that relate to a single insurance company and a single service provider, this is also done for convenience in description, and it should be understood that the architecture 100 of FIG. 1 may be modified to support multiple service providers and/or insurance companies. For example, the architecture 100 of FIG. 1 may be used, mutatis mutandis, for instances wherein an insurance company receives services from multiple service providers, and/or for instances where a service provider provides services to multiple insurance companies.

As mentioned above, the auditing application 112 of FIG. 1 provides functionality for verifying/validating the self-audit results provided by the service provider, as well as for analyzing and generating reports related to the self-audit results. FIGS. 3A-8 show a number of example windows that may be generated and displayed by the auditing application 112.

FIG. 3A shows a “Main Menu” window 300. This window 300 is displayed by the auditing application 112 when the auditing application 112 is first initialized. The “Main Menu” window 300 includes a “Service Provider Info” area 310 and an “Invoicing” area 330.

The “Invoicing” area 330 includes an “Individual Invoices” button 332. In response to user input that indicates that the “Individual Invoices” button 332 has been selected, the auditing application 112 navigates to another window (not shown in FIG. 3A) that displays individual invoices that have been received from the service provider.

The “Service Provider Info” area 310 includes a number of different buttons 312, 314, 316, 318, 320, 322, 324, 326 that correspond to a different team or functional area at the service provider. When one of these buttons 312, 314, 316, 318, 320, 322, 324, 326 is selected, the auditing application 112 navigates to another menu window that provides additional information regarding the corresponding team/functional area. An example of one of these additional menu windows is described below with reference to FIG. 3B.

In response to user input that indicates that the “Service Level Agreements” button 364 has been selected, the auditing application 112 navigates to another window (not shown in FIG. 3A) that displays the SLAs between the service provider and the insurance company.

In response to user input that indicates that the “Employee Master List” button 366 has been selected, the auditing application 112 navigates to another window (not shown in FIG. 3A) that displays a master list of employees at the service provider who are authorized to provide services to the insurance company.

As shown in FIG. 3A, the “Main Menu” window 300 includes a single “Service Provider Info” area 310 that relates to the one service provider. In an instance where the insurance company used multiple service providers, the “Main Menu” window 300 would include additional corresponding service provider areas (similar/analogous to the “Service Provider Info” area 310) for the additional other service providers.

FIG. 3B shows an example window 350 that may be displayed by the auditing application 112 when the “Customer Care Team” button 314 of FIG. 3A is selected. The window 350 of FIG. 3 includes three buttons, a “Validate Audit Data” button 352, a “Detailed Audit Data” button 354, and a “Summary Audit Data” button 356.

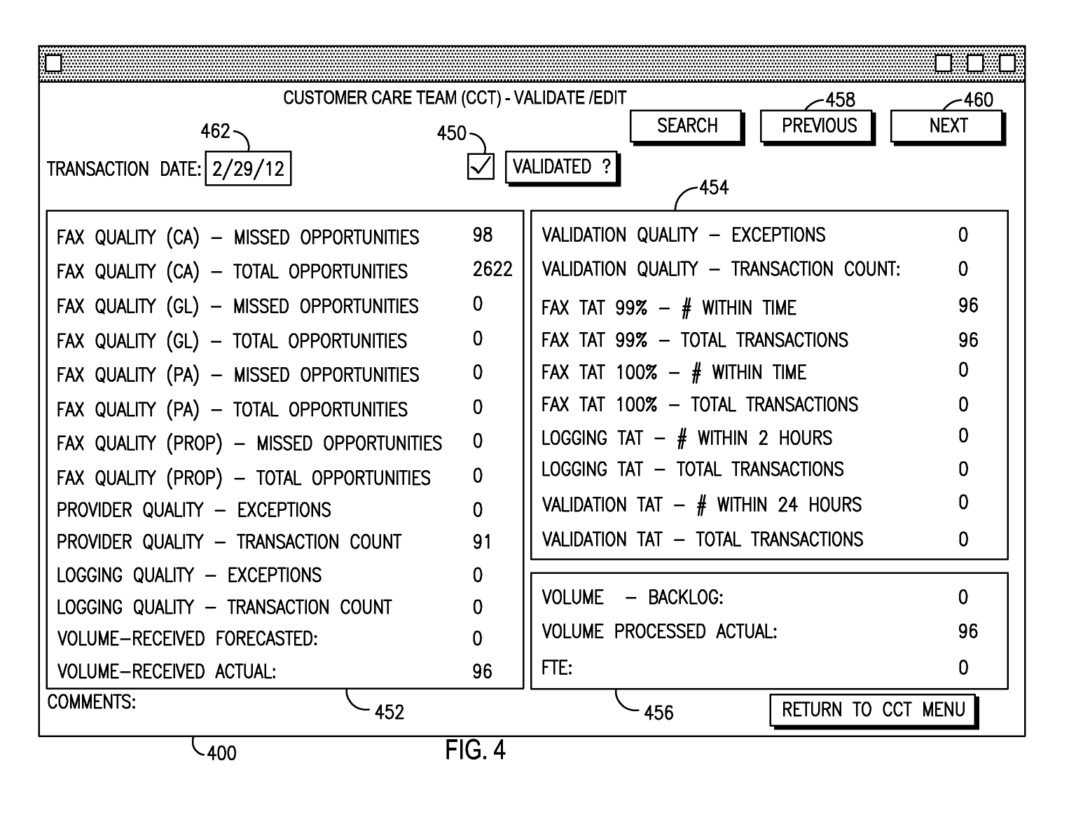

In response to selection of the “Validate Audit Data” button 352, the auditing application 112 navigates to a window that may be used to validate/verify self-audit data that has been provided by the service provider (and which is stored in the database 106). An example of such a window is shown in FIG. 4, and is described in detail below.

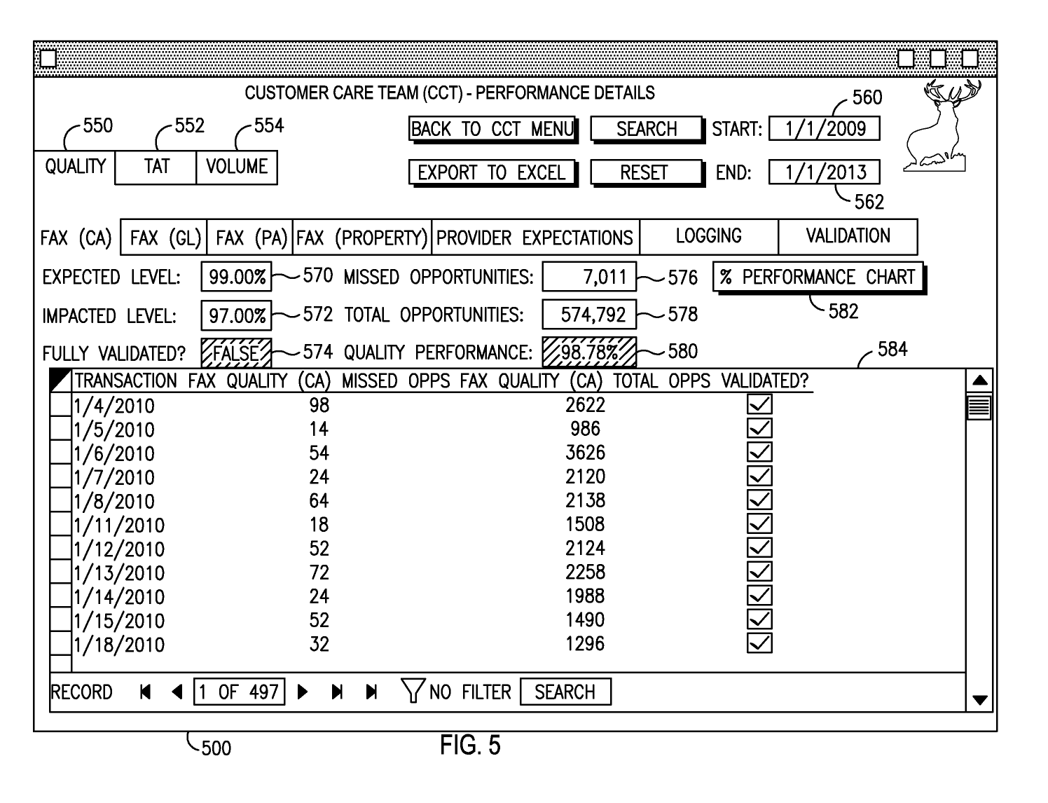

In response to selection of the “Detailed Audit Data” button 354, the auditing application 112 navigates to a window that displays a detailed view of self-audit data that has been provided by the service provider (and which is stored in the database 106). An example of such a window is shown in FIG. 5, and is described in detail below.

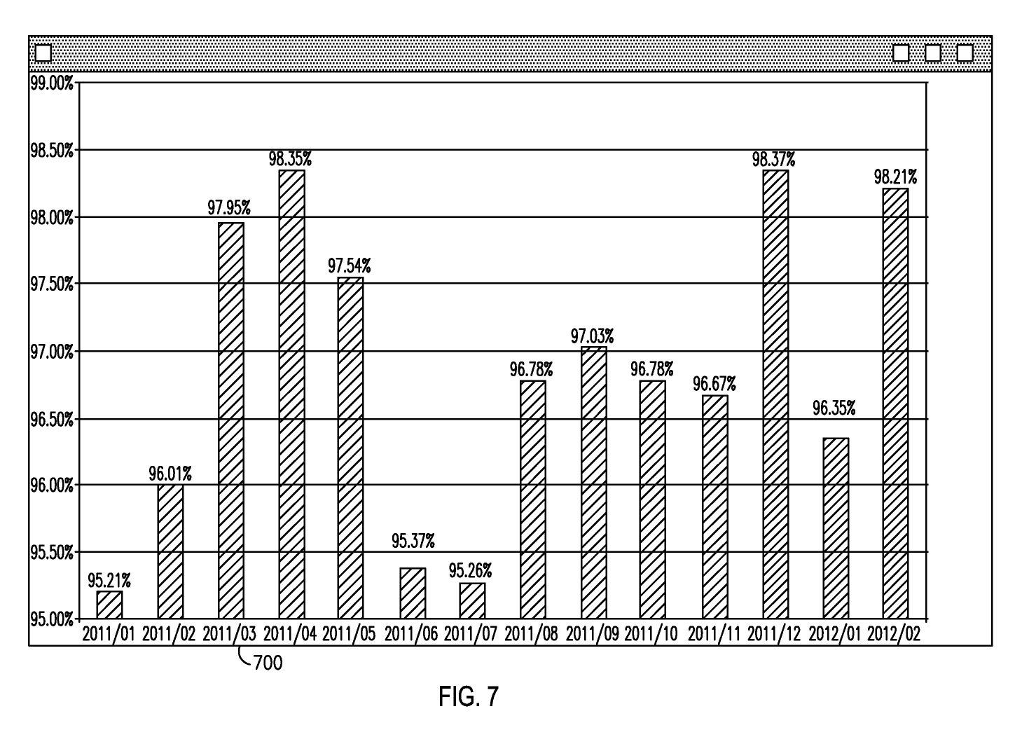

In response to selection of the “Summary Audit Data” button 356, the auditing application 112 navigates to a window that displays a summary view of the self-audit data that has been provided by the service provider (and which is stored in the database 106). An example of such a window is shown in FIG. 8, and is described in detail below.

The window 350, as mentioned above, is displayed by the auditing application 112 when the “Customer Care Team” button 314 of FIG. 3A is selected. The auditing application 112 may also display similar/analogous windows to the window 350 of FIG. 3B in response to selections of the other buttons 312, 314, 316, 318, 320, 322, 324, 326 in the window 300 of FIG. 3A that correspond to different teams/functional areas at the service provider.

FIG. 4 shows a window 400 that is displayed by the auditing application 112 in response to the to selection of the “Validate Audit Data” button 352 of the window 350 of FIG. 3B, and which may be used for entering data and independently validating/verifying self-auditing data provided by the service provider. The window 400 of FIG. 4 includes three input areas 452, 454, 456, each of which includes a number of text fields. The window 400 also includes a date field 462, a previous button 458, a next button 460, and a validated checkbox 450.

In the input areas 452, 454, 456, the text fields include data that relates to tasks performed by the service provider for the date indicated in the data field 462. When viewing the window 400 of FIG. 4, the user of the auditor client device 110 also views the relevant task-related data, to determine whether the self-audit data provided by the service provider is accurate. This may include the user viewing identical or similar data as that described above as viewed by the original auditor at the service provider (as described above with reference to FIG. 2), to determine whether the original auditor's input was correct. Once the user has determined that the data provided by the service provider is accurate, the user checks the check box 450 in the window 400. By checking the check box 450, the user of the auditor client device 110 indicates that they have independently validated/verified the self-audit data provided by the service provider for the date indicated in the date field 462.

In response to selection of the “Next” button 460, the auditing application 112 updates the data shown in the window 400, such that it corresponds to the date that is after than the date indicated in the date field 462. The auditing application 112 performs an analogous action in response to a selection of the “Previous” field 458.

FIG. 5 shows an example window 500 that may be displayed by the auditing application 112 in response to selection of the “Detailed Audit Data” button 354 of the window 350 of FIG. 3B, and which provides a detailed view of self-audit data that has been provided by the service provider and validation/verification data provided by the insurance company. FIG. 5 continues the example of FIG. 2 described above, wherein the service provider (specifically, the Customer Care Team (CCT) at the service provider) provides fax transcription services to the different business lines in the insurance company. As will be described in further detail below, the window 500 of FIG. 5 displays data related to the performance of the fax transcription services on a per-service and per-performance metric basis.

The window 500 of FIG. 5 includes three tabs, a “Quality” tab 550, “TAT tab 552, and a “Volume” tab 554. Each of these tabs 550, 552, 554 corresponds to a category of performance metric (i.e., quality, task TAT, or task volume). The “Quality” tab 550 includes a number of sub-tabs, such as the “Fax (CA)” sub-tab, “Fax (GL)” sub-tab, and so on. Each of the sub-tabs corresponds to one of the services provided by the CCT; the “Fax (CA)” sub-tab corresponds to the commercial automobile insurance fax transcription service, the “Fax (GL)” sub-tab corresponds to the general liability insurance fax transcription service, and so on. In the window 500 of FIG. 5, the “Quality” tab 550 and the “Fax (CA)” sub-tab are selected, and so the “Fax (CA)” sub-tab is displayed.

The window 500 of FIG. 5 also includes a start date field 560, an end date field 562, and, within the “Fax (CA)” sub-tab, an expected level field 570, impacted level field 572, fully validated field 574, missed opportunities field 576, total opportunities field 578, quality performance field 580, performance chart button 582, and audit data table 584.

The expected level field 570 shows the “expected” level of quality for the service provider for the Fax (CA) service, as defined in the SLA between the service provided and the insurance company. Similarly, the impacted level field 572 shows the “impacted” level of quality for the Fax (CA) service.

The audit data table 584 shows self-audit data provided by the service provider, as well as whether the data has been validated by the insurance company. The audit data table 584 includes data for the relevant service (Fax (CA)) for the time period that is specified in the start date field 560 and the end date field 562. The audit data table 584 includes four columns, which indicate the following for each row: the “Transaction” column indicates a date for the row: the “Fax Quality (CA)—Missed Opps” column indicates how many opportunities were missed (according to the audit data) in the service on that date; the “Fax Quality (CA)—Total Opps” column indicates the total number of opportunities (according to the audit data) in the service on that date; and the “Validated” column indicates whether the values provided by the service provider for the “Fax Quality” parameters for the given data have been validated/verified by the insurance company (i.e., by the user of the auditor client device 110). If, for example, the data for a given date has been validated using the window 400 of FIG. 4, then the corresponding checkbox in the “Validated” column would indicate a “checked” status.

The missed opportunities field 576 indicates the total number of missed opportunities in the service for the time period specified in the start date field 560 and the end date field 562, while the total opportunities field 578 indicates the total number of missed opportunities in the service for the time period specified in the start date field 560 and the end date field 562. Phrased another way, the missed opportunities field 576 and total opportunities field 578 indicate the totals of the “Fax Quality (CA)—Missed Opps” column and the “Fax Quality (CA)—Total Opps” column, respectively, in the audit data table 584. The quality performance field 580 indicates percentage of opportunities that were successfully converted during the time period specified in the start date field 560 and the end date field 562. Phrased another way, the quality performance field 580 indicates the ratio of missed opportunities indicated in the missed opportunities field 576 relative to the total opportunities indicated in the total opportunities field 578, indicated as a percentage.

The auditing application 112 may adjust the appearance of the quality performance field 580 in a number of different ways, depending upon the value of the quality performance field 580 and how the value compares the expected minimum quality values and impacted minimum quality value for the SLA for the service. As one example, the auditing application 112 may display the quality performance field 580 with green highlighting if the value is greater than the expected level, as yellow if the value is between the expected and impacted levels, and as red if below the impacted level.

In response to selection of the performance chart button 582, the auditing application 112 displays a window (not shown in FIG. 5) that includes a chart that reflects that information shown in the audit data table 584.

To determine the value for the fully validated field 574, the auditing application 112 analyzes, for each date shown in the data table 558 (i.e., each date within the range specified in the start date field 560 and the end date field 562), whether the audit data for the Fax CA service for that date has been validated/verified by the insurance company. If the data for each and every date in the time range has been validated/verified, then the auditing application 112 sets the value for the fully validated field 574 to be “True”; if one or more of the data in the relevant time range has not been validated/verified, then the auditing application 112 sets the value for the fully validated field 574 to be “False.”

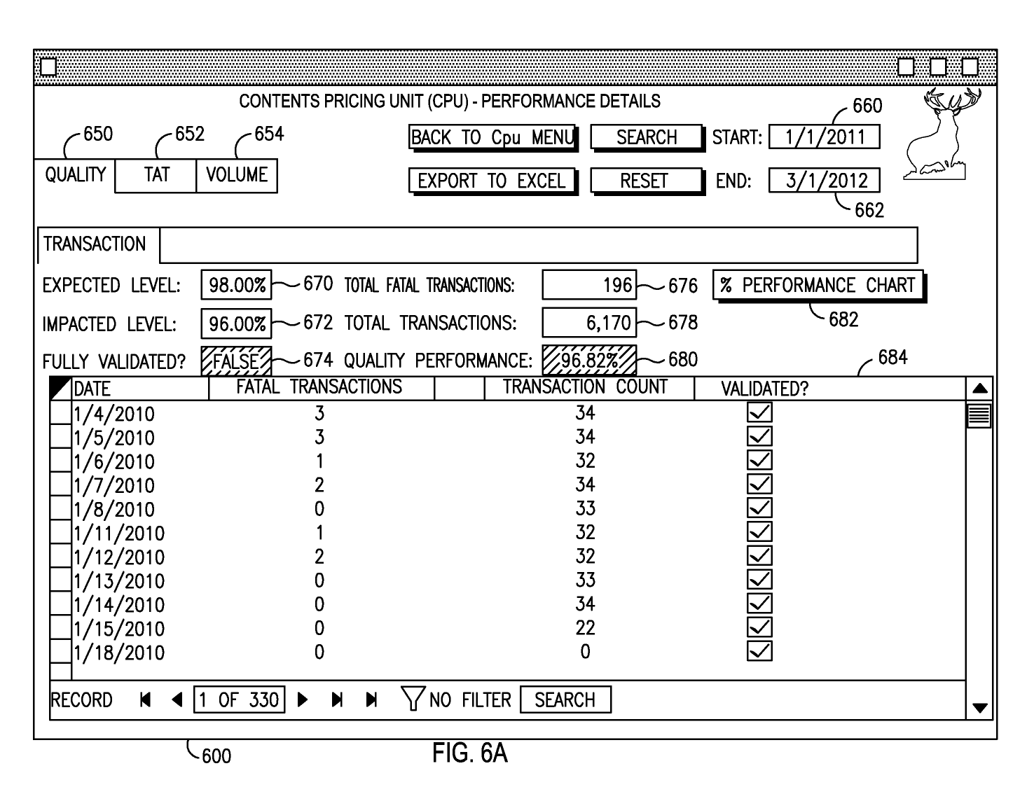

FIGS. 6A-6B show a window 600 that is similar/analogous to the window 500 of FIG. 5, but relates to a different team/functional area within the service provider. The window 600 of Figure relates to the Contents Pricing Unit (CPU) in the service provider, and may be navigated to by way of, for example, the “Contents Pricing Unit (CPU)” button 316 in the window 300 of FIG. 3A.

The window 600 of FIGS. 6A-6B includes three tabs: a “Quality” tab 650; a “TAT” tab 652; and a “Volume” tab 654. FIG. 6A shows the window 600 when the “Quality” tab 650 is selected; FIG. 6B shows the window 600 when the “TAT” tab 652 is selected. As shown in FIGS. 6A-6B, the window 600 includes a start time field 660 and an end time field 662. Also as shown in FIG. 6A, the “Quality” tab 650 includes a number of user interface elements 670, 672, 674, 676, 678, 680, 682, 684 that have similar/analogous characteristics to the corresponding elements 570, 572, 574, 576, 578, 580, 582, 584 shown in the window 500 FIG. 5. Similar, the “TAT” tab 652, as shown in FIG. 6B, includes a number of user interface elements 610, 612, 614, 616, 618, 620, 622, 624 that have similar/analogous characteristics to the corresponding elements 570, 572, 574, 576, 578, 580, 582, 584 shown in the window 500 FIG. 5.

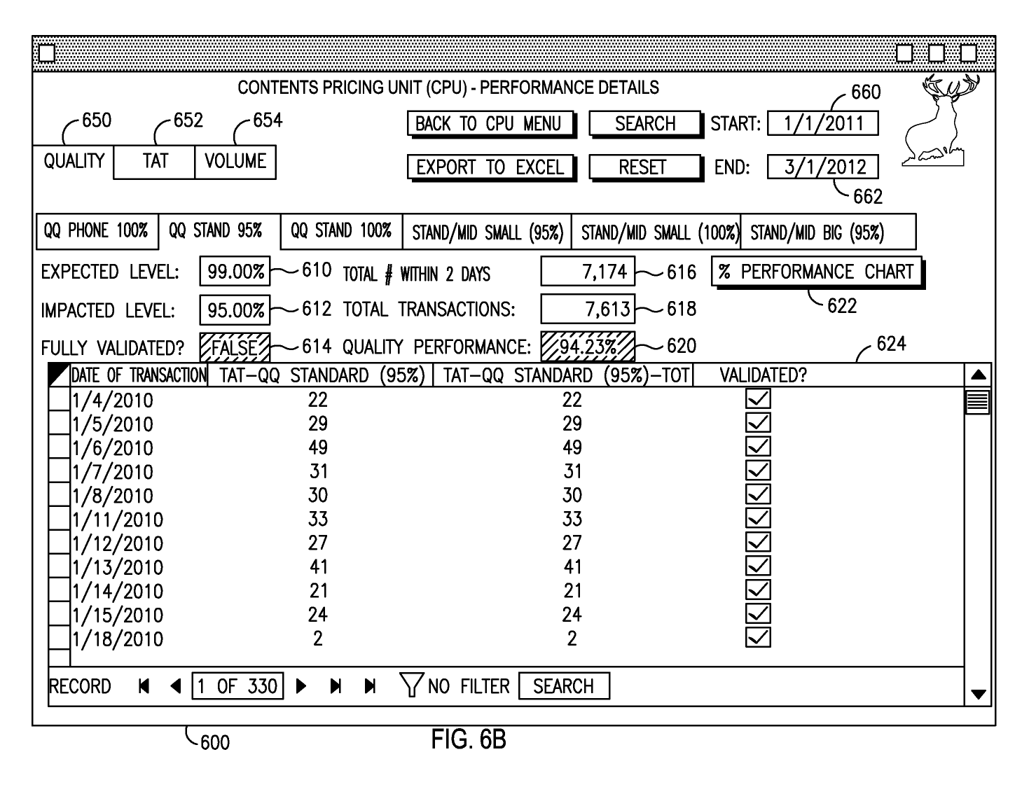

Alternatively or additionally, when the performance chart button 682 in the “Quality” tab 650 (as shown in FIG. 6A) is selected, the auditing application 112 displays a window that includes a chart that reflects that information shown in the audit data table 684. One example of a window that the auditing application 112 may display in response to selection of the performance chart button 682 is the window 700 of FIG. 7.

FIG. 8 shows an example window 800 that may be displayed by the auditing application 112 in response to selection of the “Summary Audit Data” button 356 of the window 350 of FIG. 3B, and which provides a summary view of self-audit data that has been provided by the service provider and validation/verification data that has been provided by the insurance company. The example of FIG. 8 continues the example of FIG. 5 and FIG. 2 described above, wherein the service provider (specifically, the CCT at the service provider) provides fax transcription services to the different business lines in the insurance company.

The window 800 of FIG. 8 includes a fully validated field 850, a start date field 852, and an end date field 854. The window 800 of FIG. 8 also includes a number of service performance metric areas 860, 862, 864, 866, 868, 870, 872, 874, 876, 878, 880, each of which relates to services provided by the CCT and performance metrics used to judge performance of the service. For example, the “Fax Quality (CA)” performance metric area 860 relates to a quality/accuracy metric related to the commercial automobile insurance fax transcription service provided by the CCT.

The start date field 852 and end date field 854 specify a time range, and the information indicated in the service performance metric areas 860, 862, 864, 866, 868, 870, 872, 874, 876, 878, 880 relates to audit data (and audit validation data) within the specified time range.

Each of the performance metric areas 860, 862, 864, 866, 868, 870, 872, 874, 876, 878, 880 includes a “Performance” field (such as the “Performance” field 882 in the “Validation Quality” performance metric area 872 and the “Performance” field 884 in the “Validation TAT” performance metric area 884). The auditing application 112 may adjust the appearance of these “Performance” fields, depending upon the values for these fields and how they compare to the expected minimum quality values and impacted minimum quality value for the relevant SLA. This may be performed in a fashion similar to that described above with reference to quality performance field 580 shown in and described with reference to FIG. 5 (wherein green/yellow/red highlighting are used), and/or according to any other appropriate approach.

To determine the value for the fully validated field 850, the auditing application 112 analyzes whether the audit data for that date has been validated/verified by the insurance company, for each date in the time range specified in the start date field 852 and the end date field 854, and for all of the services to which the performance metric areas 860, 862, 864, 866, 868, 870, 872, 874, 876, 878, 880 relate. If all of the above-mentioned audit data (for all dates in the time range, for all of the services) has been validated/verified, then the auditing application 112 sets the value for the fully validated field 850 to be “True”; if any of the data has not been validated/verified, then the auditing application 112 sets the value for the fully validated field 850 to be “False.”

It should be noted that the auditing application 112 determines the value for the fully validated field 850 in the window 800 of FIG. 5 in a similar manner to how the auditing application 112 determines the value for the fully validated field 574 in the window 500 of FIG. 5. However, with the fully validated field 574 of FIG. 5, the auditing application 112 determines the value based only the data from a single service (i.e., the Fax (CA) service); and with the fully validated field 850 of FIG. 8, the auditing application 112 determines the value based on all of the services to which the performance metric areas 860, 862, 864, 866, 868, 870, 872, 874, 876, 878, 880 relate.

FIG. 9 shows an example method 900 that may be performed using the architecture 100 of FIG. 1. The method 900 of FIG. 9 begins (at step 902) with the service provider providing services to the insurance company. The services may include a fax transcription service, a data entry service, and/or any other service or combination of services described herein. This step may be performed, for example, using the BPO server application 122 in the BPO server 120 and the BPO client application 132 in the worker device 130, as described above with respect to FIG. 1. Data related to the performance of the services may be stored in the database 106 in the insurance company network 102. For example, at the completion of a task according to one of the services, a new task completion record may be added to the database 106, indicating information such as when the task was assigned, when the task was completed, and/or other information related to the task.

Next, at step 904, the service provider performs a self-audit of the task completion records added to the database 106 at step 902. This may be done, for example, using the BPO client application 142, the BPO server application 122, and/or the window 200 of FIG. 2, as described above. Audit data generated at this step may be stored in the database 106 in the insurance company network 102. The audit data may relate to a given overall time period (such as one week, one month, one quarter of a year, one half of a year, or any other appropriate time period), which is made up of a number of shorter time periods (e.g., one day). Additionally, the audit data relates to some subset of the entire set of tasks that were performed during the given overall time period (i.e., relates to some subset of the task completion data added to the database 106 at step 902). In most instances, the subset of tasks is selected to be of a statistically significant size—for example, the subset relates to 20% of the tasks performed during the time period, or 30% of the tasks performed during the time period, 40% of the tasks performed during the time period, or any other appropriate statistically significant sample size. Additionally, in most instances, the task completion records audited during step 904 are a strict subset of the task completion records added at step 902 (i.e., are less than the entire set of task completion records added at step 902).

At step 906, a user of the auditing application 112 may perform a validation of the audit data generated and stored at step 906. This validation is performed on a subset of the tasks that were self-audited by the service provider at step 904; in other words, the validation is performed on a subset of a subset of the tasks for the given overall time period. Again, in most instances, the subset of the tasks that are validated are selected to be of a statistically significant size (e.g., 30%, 40%, or 50% of the tasks audited by the service provider, or any other statistically significant sample size), but are also selected to be a strict subset of the tasks audited by the service provider. The validation may be performed using, for example, the window 400 of FIG. 4. Validation data (i.e., data that indicates which portions of the audit data have been validated) may be stored in the database 106.

At step 908, the auditing application 112 may generate reporting information related to the audit data and the validation data stored in the database 106. The reporting information may indicate include raw audit data (i.e., the total number of opportunities for a particular service on a given day and the total of missed opportunities for the same day), information that indicates whether the service provider has been meeting SLA requirements, to what extent the audit data has been validated, and/or other information. The reporting information may be displayed by the auditing application 112 in user interface elements such as, for example, the window 500 of FIG. 5, the window of FIGS. 6A-6B, the window 700 of FIG. 7, the window 800 of FIG. 8, and/or any other appropriate user interface element.

At step 910, one or more actions may be performed based on the audit data and the validation data. These actions may be performed by the auditing application 112 and/or the messaging/alert module 152 in the messaging/alert server 150. As one example, the messaging/alert module 152 may, at step 910, analyze (based on data in the database 106) whether the data for all of the time periods within the overall given time period has been validated, and may generate and transmit an alert message (such as an email message) to the user of the audit supervisor device 160 that indicates whether data for all of the time periods has been validated and/or what percentage of the data has been validated.

As another example, step 910 may include the messaging/alert module 152 analyzing data stored in the database 106, to determine whether the service provider's performance levels for the given time period have met the expected performance levels as defined in the relevant SLAs. If not, the messaging/alert module 152 may generate and transmit an alert message (such as an email message) to the user of the audit supervisor device 160. Alternatively or additionally, the messaging/alert module 152 may determine whether, due to performance below the expected performance levels, service credits and/or a fee rebate may be due to the insurance company, and determine (if any) the number of service credits and/or fee rebate amount; if service credits and/or a fee rebate is due to the insurance company, then the alert message may indicate the number of service credits and/or the rebate fee amount. Alternatively or additionally, the volume of work performed by the service provider on the audited/validated tasks during the time period which have been audited/validated is compared by the messaging/alert module 152 against the number of workers that the service provider agreed to staff on the tasks for the time period. If the messaging/alert module 152 determines that less tasks were completed than would have been expected (given the number of workers that the service provider agreed to staff on the tasks), then the alert message may indicate as much.

Alternatively or additionally, step 910 may include the messaging/alert module 152 analyzing the number of tasks (i.e., the number of task completion records) that were audited by the service provider (at step 904) and validated by the insurance company (at step 906) to determine whether a minimum threshold for the number of audited tasks and a minimum threshold for the number of validated tasks have been met. In an instance where the minimum threshold for the number of audited tasks has not been met or the minimum threshold for the number of validated tasks has not been met, the messaging/alert module 152 may generate and transmit an alert message (such as an email message) to the user of the audit supervisor device 160, indicating that the threshold(s) was/were not met.

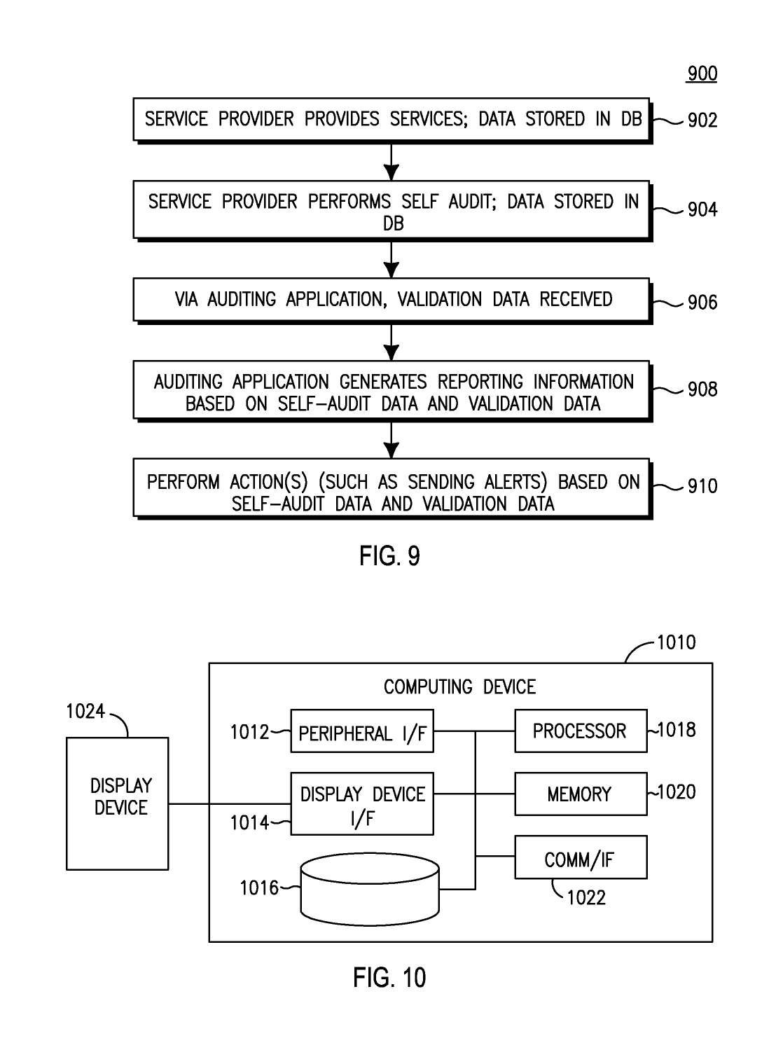

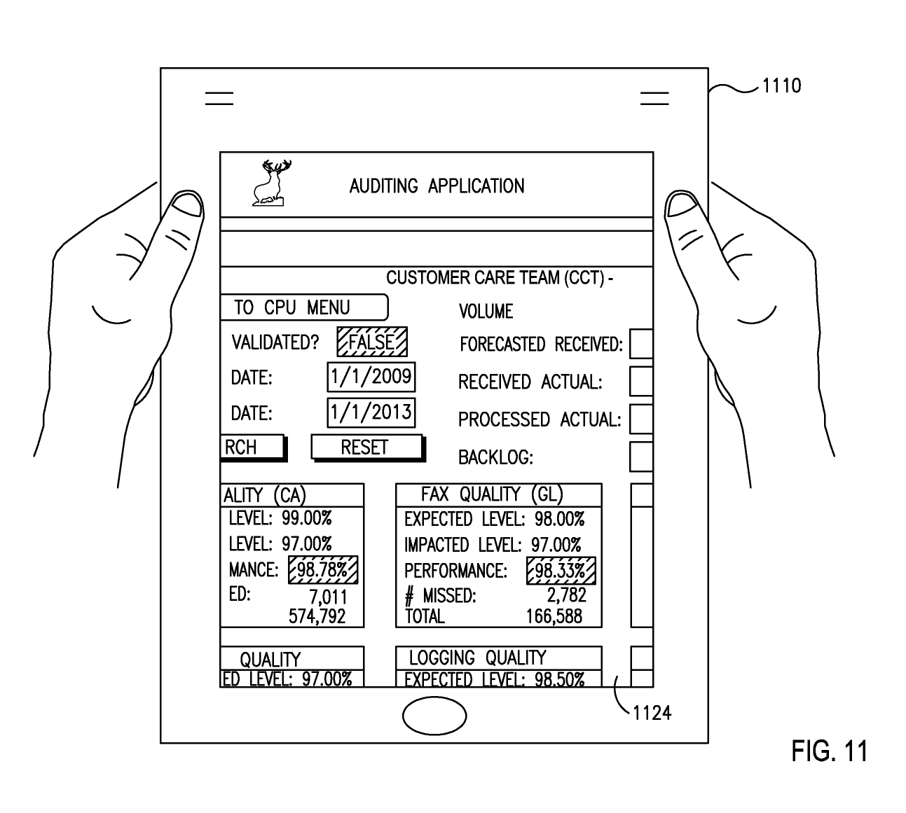

For convenience in description, the auditing application 112, BPO server application 122, BPO client applications 132, 142, messaging/alert module 152, and messaging client application 162 are described herein as performing various actions. However, it should be understood that the actions described herein as performed by these applications/modules 112, 122, 132, 142, 152, 162 are actually performed by hardware/circuitry (i.e., processors, network interfaces, memory devices, data storage devices, input devices, and/or display devices) in the respective devices 110, 120, 130, 140, 150, 160 where the applications/modules 112, 122, 132, 142, 152, 162 are stored/executed. Examples and further details regarding how these devices 110, 120, 130, 140, 150, 160 and these applications 112, 122, 132, 142, 152, 162 may be implemented are provided below with reference to, inter alia, FIG. 10 and FIG. 11.

FIG. 10 shows an example computing device 1010 that may be used to implement features described herein as performed in the auditor client device 110, BPO server 120, service provider worker device 130, service provider auditor device 140, messaging/alert server 150, and/or audit supervisor device 160. The computing device 1010 includes a processor 1018, memory device 1020, communication interface 1022, peripheral device interface 1012, display device interface 1014, and data storage device 1016. FIG. 10 also shows a display device 1024, which may be coupled to or included within the computing device 1010.

The memory device 1020 may be or include a device such as a Dynamic Random Access Memory (D-RAM), Static RAM (S-RAM), or other RAM or a flash memory. The data storage device 1016 may be or include a hard disk, a magneto-optical medium, an optical medium such as a CD-ROM, a digital versatile disk (DVDs), or Blu-Ray disc (BD), or other type of device for electronic data storage.

The communication interface 1022 may be, for example, a communications port, a wired transceiver, a wireless transceiver, and/or a network card. The communication interface 1022 may be capable of communicating using technologies such as Ethernet, fiber optics, microwave, xDSL (Digital Subscriber Line), IEEE 802.11 technology, Wireless Local Area Network (WLAN) technology, wireless cellular technology, and/or any other appropriate technology.

The peripheral device interface 1012 is configured to communicate with one or more peripheral devices. The peripheral device interface 1012 operates using a technology such as Universal Serial Bus (USB), PS/2, Bluetooth, infrared, serial port, parallel port, and/or other appropriate technology. The peripheral device interface 1012 may, for example, receive input data from an input device such as a keyboard, a mouse, a trackball, a touch screen, a touch pad, a stylus pad, and/or other device.

The display device interface 1014 may be an interface configured to communicate data to display device 1024. The display device 1024 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 1014 may operate using technology such as Video Graphics Array (VGA), Super VGA (S-VGA), Digital Visual Interface (DVI), High-Definition Multimedia Interface (HDMI), or other appropriate technology. The display device interface 1014 may communicate display data from the processor 1018 to the display device 1024 for display by the display device 1024. As shown in FIG. 10, the display device 1024 may be external to the computing device 1010, and coupled to the computing device 1010 via the display device interface 1014. Alternatively, the display device 1024 may be included in the computing device 1000.

An instance of the computing device 1010 of FIG. 10 may be configured to perform any feature or any combination of features described above as performed by the auditor client device 110. Alternatively or additionally, the memory device 1020 and/or the data storage device 1016 may store instructions which, when executed by the processor 1018, cause the processor 1018 to perform any feature or any combination of features described above as performed by the auditing application 112 in the auditor client device 110. Alternatively or additionally, each or any of the features described above as performed by auditing application 112 may be performed by the processor 1018 in conjunction with the memory device 1020, communication interface 1022, peripheral device interface 1012, display device interface 1014, and/or data storage device 1016, as appropriate.

An instance of the computing device 1010 of FIG. 10 may be configured to perform any feature or any combination of features described above as performed by the BPO server 120. Alternatively or additionally, the memory device 1020 and/or the data storage device 1016 may store instructions which, when executed by the processor 1018, cause the processor 1018 to perform any feature or any combination of features described above as performed by the BPO server application 122 in the BPO server 120. Alternatively or additionally, each or any of the features described above as performed by BPO server application 122 may be performed by the processor 1018 in conjunction with the memory device 1020, communication interface 1022, peripheral device interface 1012, display device interface 1014, and/or data storage device 1016, as appropriate.

An instance of the computing device 1010 of FIG. 10 may be configured to perform any feature or any combination of features described above as performed by the service provider worker device 130. Alternatively or additionally, the memory device 1020 and/or the data storage device 1016 may store instructions which, when executed by the processor 1018, cause the processor 1018 to perform any feature or any combination of features described above as performed by the BPO client application 132 in the service provider worker device 130. Alternatively or additionally, each or any of the features described above as performed by BPO client application 132 may be performed by the processor 1018 in conjunction with the memory device 1020, communication interface 1022, peripheral device interface 1012, display device interface 1014, and/or data storage device 1016, as appropriate.

An instance of the computing device 1010 of FIG. 10 may be configured to perform any feature or any combination of features described above as performed by the service provider auditor device 140. Alternatively or additionally, the memory device 1020 and/or the data storage device 1016 may store instructions which, when executed by the processor 1018, cause the processor 1018 to perform any feature or any combination of features described above as performed by the BPO client application 142 in the service provider auditor device 140. Alternatively or additionally, each or any of the features described above as performed by BPO client application 142 may be performed by the processor 1018 in conjunction with the memory device 1020, communication interface 1022, peripheral device interface 1012, display device interface 1014, and/or data storage device 1016, as appropriate.

An instance of the computing device 1010 of FIG. 10 may be configured to perform any feature or any combination of features described above as performed by the messaging/alert server 150. Alternatively or additionally, the memory device 1020 and/or the data storage device 1016 may store instructions which, when executed by the processor 1018, cause the processor 1018 to perform any feature or any combination of features described above as performed by the messaging/alert module 152 in the messaging/alert server 150. Alternatively or additionally, each or any of the features described above as performed by messaging/alert module 152 may be performed by the processor 1018 in conjunction with the memory device 1020, communication interface 1022, peripheral device interface 1012, display device interface 1014, and/or data storage device 1016, as appropriate.

An instance of the computing device 1010 of FIG. 10 may be configured to perform any feature or any combination of features described above as performed by the audit supervisor device 160. Alternatively or additionally, the memory device 1020 and/or the data storage device 1016 may store instructions which, when executed by the processor 1018, cause the processor 1018 to perform any feature or any combination of features described above as performed by the messaging client application 162 in the audit supervisor device 160. Alternatively or additionally, each or any of the features described above as performed by messaging client application 162 may be performed by the processor 1018 in conjunction with the memory device 1020, communication interface 1022, peripheral device interface 1012, display device interface 1014, and/or data storage device 1016, as appropriate.

FIG. 11 shows a tablet computer 1110 that is a more specific example of the computing device 1010 of FIG. 10. The tablet computer 1110 may include a processor (not depicted), memory device (not depicted), communication interface (not depicted), peripheral device interface (not depicted), display device interface (not depicted), storage device (not depicted), and touch screen display 1124, which may possess characteristics of the processor 1018, memory device 1020, communication interface 1022, peripheral device interface 1012, display device interface 1014, storage device 1016, and display device 1024, respectively, as described above with reference to FIG. 10. The touch screen display 1124 may receive user input using technology such as, for example, resistive sensing technology, capacitive sensing technology, optical sensing technology, or any other appropriate touch-sensing technology.

Although features are described above that relate to an insurance company and a service provider that provides services to the insurance company, the features herein are also applicable and/or may be used by, mutatis mutandis, any type of business (including but not limited to a financial services company or other type of business), any type of non-business organization, and/or any individual. Alternatively or additionally, although features are described herein with reference to the architecture 100 of FIG. 1, the methods and features described herein may be performed, mutatis mutandis, using any appropriate architecture, network topology, and/or computing environment.

As used herein, the term “processor” refers to a device such as a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), a state machine, and/or a similar type of device.

As used to herein, the term “computer-readable medium” refers to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, and/or other type of device for electronic data storage.

As used herein, the term “a” or “an” entity refers to one or more of that entity. As such, the terms “a” (or “an”), “one or more,” and “at least one” as used herein should be understood to be interchangeable.

Although features and elements are described herein in particular combinations, each feature or element can be used alone or in any combination with or without the other features and elements. For example, each feature or element as described above with reference to any Figure or any combination of Figures may be used alone without the other features and elements or in various combinations with or without other features and elements. Sub-elements and/or sub-steps of the methods described herein with reference to any Figure or any combination of Figures may be performed in any arbitrary order (including concurrently), in any combination or sub-combination.

What is claimed is:

1. A system for validating audit data that is related to a service provided by a service provider to an insurance company, wherein the service includes the performance of repeatable insurance related tasks, the system comprising:
a data storage device configured to store:
information that defines a service level agreement (SLA) between the service provider and the insurance company, wherein the service is performed according to the SLA;
information that includes task completion records for a plurality of the insurance related tasks completed by the service provider according to the SLA, wherein the task completion records include, for each of the insurance related tasks, information that uniquely identifies the insurance related task and information that indicates a time the insurance related task was completed; and
audit information that indicates a level of performance for the plurality of the insurance related tasks completed by the service provider,
wherein the audit information indicates the level of performance for the insurance related tasks for each of a plurality of time periods,
wherein the audit information is based on only a first subset of the task completion records, wherein the first subset of the task completion records is a strict subset of the task completion records, and
wherein the audit information is provided by the service provider;
a processor configured to:
receive user input data that indicates whether the audit information has been validated for one or more of the time periods,
wherein the audit information is considered validated for one of the time periods when the level of performance for the plurality of the insurance related tasks for the time period indicated in the audit information has been independently verified as correct by the insurance company, and
wherein the user input data is based on only a second subset of the task completion records, wherein the second subset of the task completion records is a strict subset of the first subset of the task completion records;
generate a user interface element that includes a validation information area, wherein the validation information area indicates whether the audit information has been validated for all of the time periods or only a portion of the time periods; and
a display device configured to display the user interface element.

2. The system of claim 1, wherein the service is one of: a workers' compensation correspondence management service; an insurance coverage verification service; or a disability insurance intake service.

3. The system of claim 1, wherein the service is one of: a fax transcription service; a data entry service; a contents pricing service; a payment processing service; a customer care service; or an exception handling service.

4. The system of claim 1,
wherein the processor is further configured to determine, based on the audit data, an aggregate level of performance for the insurance related tasks over all of the time periods, and
wherein the user interface element further includes:
an aggregate level of performance area that indicates the aggregate level of performance;
an expected level of performance area that indicates an expected level of performance for the insurance related tasks as defined according to the SLA; and
an impact level of performance area that indicates an impacted level of performance for the insurance related tasks as defined according to the SLA.

5. The system of claim 4, wherein the processor is further configured to set the appearance of the aggregate level of performance area based comparisons of the aggregate level of performance to the expected level of performance and the impacted level of performance.

6. The system of claim 1, wherein the system further comprises a communication interface, and wherein the processor is further configured to:
determine, based on the task completion records and the information that defines the SLA, whether a service credit is owed by the service provider to the insurance company;
generate an email message that indicates that the service credit is owed by the service provider to the insurance company; and
transmit, via the communication interface, the email message.

7. The system of claim 1, wherein the system further comprises a communication interface, and wherein the processor is further configured to:
generate an email message that indicates whether the audit information has been validated for all of the time periods or only a portion of the time periods; and
transmit, via the communication interface, the email message.

8. A computer-implemented method for validating audit data that is related to a service provided by a service provider to a financial services company, wherein the service includes the performance of repeatable business tasks, the method comprising:
storing, in a data storage device:
information that includes task completion records for a plurality of the business tasks completed by the service provider; and
audit information for each of a plurality of time periods,
wherein the audit information indicates a level of performance of the business tasks for each the time periods,
wherein the audit information is based on only a first subset of the task completion records, wherein the first subset of the task completion records is a strict subset of the task completion records, and
wherein the audit information is provided by the service provider;
receiving, at a processor, user input data that indicates whether the audit information has been validated for one or more of the time periods,
wherein the user input data is based on only a second subset of the task completion records, wherein the second subset of the task completion records is a strict subset of the first subset of the task completion records;
generating, at the processor, a user interface element that includes a validation information area, wherein the validation information area indicates whether the audit information has been validated for all of the time periods or only a portion of the time periods; and
displaying, at a display device, the user interface element.

9. The method of claim 8, wherein the audit information is considered validated for one of the time periods when the level of performance for the business tasks for the time period indicated in the audit information has been independently verified as correct by the financial services company.

10. The method of claim 8, wherein the service is one of: a workers' compensation correspondence management service; an insurance coverage verification service; or a disability insurance intake service.

11. The method of claim 8, wherein the service is one of: a fax transcription service; a data entry service; a contents pricing service; a payment processing service; a customer care service; or an exception handling service.

12. The method of claim 8, wherein the service is provided to an insurance company pursuant to a service level agreement (SLA).

13. The method of claim 12, further comprising:
determining, at the processor, an aggregate level of performance for business tasks over all of the time periods;
wherein the user interface element further includes:
an aggregate level of performance area that indicates the aggregate level of performance;
an expected level of performance area that indicates an expected level of performance for business tasks as defined according to the SLA; and
an impact level of performance area that indicates an impacted level of performance for the business tasks as defined according to the SLA.

14. The method of claim 13, further comprising:
performing, at the processor, comparisons of the aggregate level of performance to the expected level of performance and the impacted level of performance; and
setting, at the processor, the appearance of the aggregate level of performance area based the comparisons.

15. The method of claim 8, further comprising:
determining, at the processor, whether a service credit is owed by the service provider to the insurance company based on the task completion records;
generating, at the processor, an email message that indicates that the service credit is owed by the service provider to the insurance company; and
transmit, via a communication interface, the email message.

16. The method of claim 8, further comprising:
generating, at the processor, an email message that indicates whether the audit information has been validated for all of the time periods or only a portion of the time periods; and
transmitting, via a communication interface, the email message.

17. A non-transitory computer-readable medium having processor-executable instructions stored thereon which, when executed by at least one processor, will cause the at least one processor to perform a method for communicating with a service provider for the performance of a service and for validating audit data that is related to the service,
wherein the service is a fax transcription service for transcribing faxes that relate to insurance claims,
wherein the method comprises:
the at least one processor receiving data that defines transcribed faxes that have been transcribed at the service provider, wherein the transcribed faxes are related to insurance claims;
the at least one processor storing the data that defines the transcribed faxes in a database that is stored in a data storage device;
the at least one processor storing task completion records related to the transcribed faxes in the database;
the at least one processor obtaining audit information for each of a plurality of time periods,
wherein the audit information indicates a level of performance of the service for each the time periods, and
wherein the audit information is provided by the service provider;
the at least one processor receiving, via an input interface, user input data that indicates whether the audit information has been validated for one or more of the time periods; and
the at least one processor generating information that defines a user interface element that includes a validation information area, wherein the validation information area indicates whether the audit information has been validated for all of the time periods; and
the at least one processor providing the information that defines the user interface element to a display device via a display device interface.

18. The non-transitory computer-readable medium of claim 17, wherein the audit information is considered validated for one of the time periods when the level of performance for the service for the time period indicated in the audit information has been independently verified.

19. The non-transitory computer-readable medium of claim 17, wherein the service is provided to an insurance company pursuant to a service level agreement (SLA).

20. The non-transitory computer-readable medium of claim 19, wherein the method further comprises:
the at least one processor determining an aggregate level of performance for the service over all of the time periods;
wherein the user interface element further includes:
an aggregate level of performance area that indicates the aggregate level of performance;
an expected level of performance area that indicates an expected level of performance for the service as defined according to the SLA; and
an impact level of performance area that indicates an impacted level of performance for the service as defined according to the SLA.

21. The non-transitory computer-readable medium of claim 20, wherein the method further comprises:
the at least one processor performing comparisons of the aggregate level of performance to the expected level of performance and the impacted level of performance; and
the at least one processor setting the appearance of the aggregate level of performance area based the comparisons.

22. The non-transitory computer-readable medium of claim 17, wherein the method further comprises:
the at least one processor determining whether a service credit is owed by the service provider to the insurance company based on the task completion records;
the at least one processor generating a message that indicates that the service credit is owed by the service provider to the insurance company; and
the at least one processor transmitting the message via a communication interface.

23. The non-transitory computer-readable medium of claim 17, wherein the method further comprises:
the at least one processor generating a message that indicates whether the audit information has been validated for all of the time periods or only a portion of the time periods; and
the at least one processor transmitting the message via a communication interface.
